(19) United States
(12) Patent Application Publication
(10) Pub. No.: US 2018/0141213 A1
(43) Pub. Date: May 24, 2018

(54) ANTI-COLLISION SYSTEM AND ANTI-COLLISION METHOD

(71) Applicant: INSTITUTE FOR INFORMATION INDUSTRY, TAIPEI (TW)

(72) Inventors: Wei-Huan TSAO, Taichung City (TW); Chih-Chieh LIN, Taipei City (TW); Hung-Sheng CHIU, Taipei City (TW); Hsiao-Chen CHANG, Taipei City (TW)

(21) Appl. No.: 15/588,714

(22) Filed: May 8, 2017

(30) Foreign Application Priority Data
Nov. 24, 2016 (TW) 105138684

(51) Int. Cl. B25J 9/16

(52) U.S. Cl. CPC B25J 9/1666; G05B 2219/40442; G05B 2219/40476; B25J 9/1697

(57) ABSTRACT

An anti-collision system uses for preventing an object collide with automatic robotic arm. Wherein, the automatic robotic arm includes a controller. The anti-collision system includes a first image sensor, a vision processing unit and a processing unit. The first image sensor captures a first image. The vision processing unit receives the first image, recognizes the object of the first image and estimates an object movement estimation path of the object. The processing unit is coupled to the controller to access an arm movement path. The processing unit estimates an arm estimation path of the automatic robotic arm, analyzes the first image to establish a coordinate system, and determines whether the object will collide with the automatic robotic arm according to the arm estimation path of the automatic robotic arm and the object movement estimation path of the object.

### CROSS-REFERENCE TO RELATED APPLICATION

This application claims priority to Taiwan Application Serial Number 105138684, filed Nov. 24, 2016, which is herein incorporated by reference.

### BACKGROUND

### Technical Field

The present disclosure relates to an anti-collision system and an anti-collision method. More particularly, the present disclosure relates to an anti-collision system and an anti-collision method applied to an automatic robotic arm.

### Description of Related Art

In general, the automatic robotic arm is one kind of precision machineries composed of rigid bodies and servo motor. When an unexpected collision is happened, the operation precisions of each axis of the automatic robotic arm will be impacted. Further, the unexpected collision may damage the servo motor or the components. The components in automatic robotic arm are assembled as continuous structures. Thus, all the components need to be changed in the same time when updating the components of the automatic robotic arm. Besides, the automatic robotic arm with new servo motor or new components also needs to process the test critically after updating the components. Only when the test is passed, the automatic robotic arm with new servo motor or new components can be returned to work. Therefore, the time and the cost of maintaining the automatic robotic arm are higher than other precision machineries.

Therefore, efficiently preventing the servo motor from damage can help decrease the maintaining cost of the automatic robotic arm. As such, how to detect that whether an unexpected object enters the operation region of the automatic robotic arm when the automatic robotic arm is operating, and how to immediately adjust the operation status of the automatic robotic arm when the unexpected object enters the operation region of the automatic robotic arm for preventing the servo motor from damage becomes a problem to-be solved in the art.

### SUMMARY

To address the issues, one aspect of the present disclosure is to provide an anti-collision system for preventing an object from colliding with an automatic robotic arm. The automatic robotic arm comprises a controller. The anti-collision system comprises a first image sensor, a vision processing unit and a processing unit. The first image sensor is configured to capture a first image. The vision processing unit is configured to receive the first image, recognize the object of the first image and estimate an object movement estimation path of the object. The processing unit is coupled to the controller to access an arm movement path, estimate an arm estimation path of the automatic robotic arm, analyze the first image to establish a coordinate system, and determine whether the object will collide with the automatic robotic arm according to the arm estimation path of the automatic robotic arm and the object movement estimation path of the object. The processing unit adjusts an operation status of the automatic robotic arm when the processing unit determines that the object will collide with the automatic robotic arm.

Another aspect of the present disclosure is to provide an anti-collision method for preventing an object from colliding with an automatic robotic arm. The automatic robotic arm comprises a controller. The anti-collision method comprising: capturing a first image by a first image sensor; receiving the first image, recognizing the object of the first image and estimating an object movement estimation path of the object by a vision processing unit, and accessing an arm movement path, estimating an arm estimation path of the automatic robotic arm, analyzing the first image to establish a coordinate system, and determining whether the object will collide with the automatic robotic arm according to the arm estimation path of the automatic robotic arm and the object movement estimation path of the object by a processing unit coupled to the controller. The processing unit adjusts an operation status of the automatic robotic arm when the processing unit determines that the object will collide with the automatic robotic arm.

Accordingly, the anti-collision system and the anti-collision method use the vision processing unit to recognize the object of the image and estimate an object movement estimation path of the object. And, the processing unit can determine whether the object will collide with the automatic robotic arm according to the arm estimation path of the automatic robotic arm and the object movement estimation path of the object. Besides, if the processing unit determines that an unexpected object enters the operation region when the automatic robotic arm is operating, the processing unit can immediately commands the automatic robotic arm to stop moving or to enter an adaptation mode. The adaptation mode means that the rotation angle (that is, the displacement of the arm formed by the force or the torque) of the servo motor is changed by the external force when the servo motor is in the condition without operating by internal electronic force. It can prevent the automatic robotic arm from suffering the stress in the condition of reversing movement or counterforce status. As such, the anti-collision system and the anti-collision method can achieve the effect of preventing the object from colliding with the automatic robotic arm and preventing the servo motor from breakdown.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 depicts a schematic diagram of an anti-collision system according to one embodiment of present disclosure;

FIG. 2 depicts a schematic diagram of an embedded system according to one embodiment of present disclosure;

FIG. 3 depicts a flow chart of an anti-collision method according to one embodiment of the present disclosure;

FIG. 4 depicts a flow chart of an anti-collision method according to one embodiment of the present disclosure; and

FIGS. 5A-5C depict schematic diagrams of the first image according to one embodiment of present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

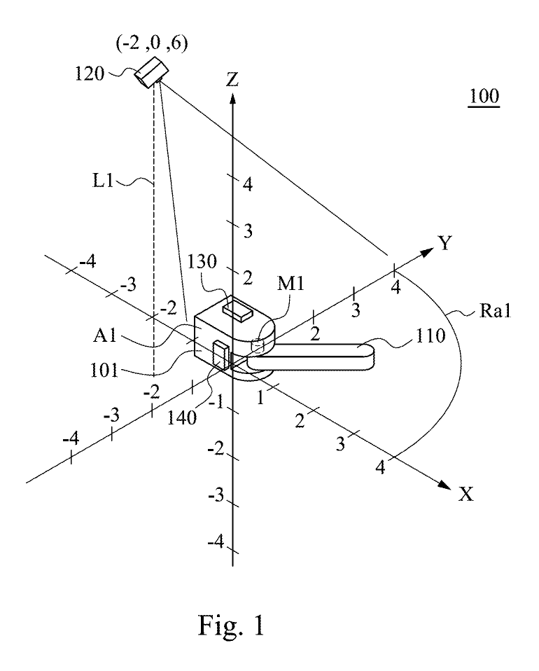

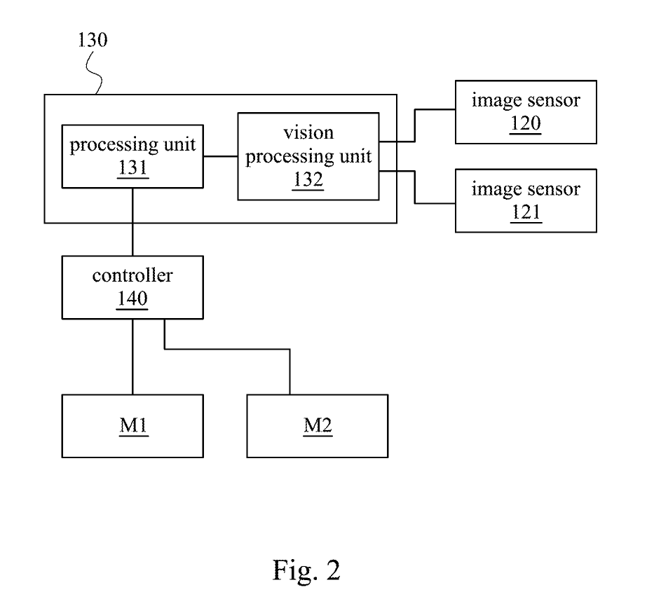

References are made to FIGS. 1-2, FIG. 1 depicts a schematic diagram of an anti-collision system 100 according to one embodiment of present disclosure. FIG. 2 depicts a schematic diagram of an embedded system 130 according to one embodiment of present disclosure. In one embodiment, the anti-collision system 100 uses for preventing an object from colliding with an automatic robotic arm A1. The automatic robotic arm A1 includes a controller 140. The controller 140 can be connected to an external computer. The operation method of the automatic robotic arm A1 can be configured by a user through application software installed in the external computer. And, the application software can transfer the operation method to the motion control code. And, the motion control code can be read by the controller 140. Thus, the controller 140 can control the operation of the automatic robotic arm A1 according to the motion control code. In one embodiment, the automatic robotic arm A1 further includes a power supply controller.

In one embodiment, the anti-collision system 100 includes the image sensor 120 and the embedded system 130. In one embodiment, the embedded system 130 can be an external embedded system. And, the external embedded system can be mounted on any part of the automatic robotic arm A1. In one embodiment, the embedded system 130 can be placed on the automatic robotic arm A1. In one embodiment, the embedded system 130 connected to the controller 140 of the automatic robotic arm A1 by a wire or a wireless communication link. And, the embedded system 130 connected to the image sensor 120 by another wire or another wireless communication link.

In one embodiment, as shown in FIG. 2, the embedded system 130 includes a processing unit 131 and a vision processing unit 132. The processing unit 131 is coupled to the vision processing unit 132. In one embodiment, the processing unit 131 is coupled to the controller 140, and the vision processing unit 132 is coupled to the image sensor 120.

In on embodiment, the anti-collision system 100 includes multiple image sensors 120, 121, and the automatic robotic arm A1 includes multiple motors M1, M2. And, the motors M1, M2 are coupled to the controller 140. The vision processing unit 132 is coupled to the multiple image sensors 120, 121.

In one embodiment, the image sensor 120 can be mounted on the automatic robotic arm A1. Or, the image sensor 120 can be configured independently at any position which can capture the automatic robotic arm A1 in the coordinate system.

In one embodiment, the image sensors 120, 121 can be composed of at least one charge coupled device (CCD) or complementary metal-oxide semiconductor (CMOS) sensor. The image sensors 120, 121 can be mounted on the automatic robotic arm A1 or separately configured at other positions in the coordinate system. In one embodiment, the processing unit 131 and controller 140 can be separately or combined by using a microcontroller, a microprocessor, a digital signal processor, an application specific integrated circuit (ASIC), or a logic circuit to implement. In one embodiment, the vision processing unit 132 uses for processing image analyzation, such as image recognition, dynamical object tracing, distance measurement of physical object or depth measurement of environment. In one embodiment, the image sensor 120 can be implemented as a three-dimensional camera, infrared camera or other depth cameras for obtaining the depth information of the image. In one embodiment, the processing unit 132 can implemented by multiple reduced instruction set computers (RISC), hardware accelerators units, high performance image signal processor or high-speed peripheral interface.

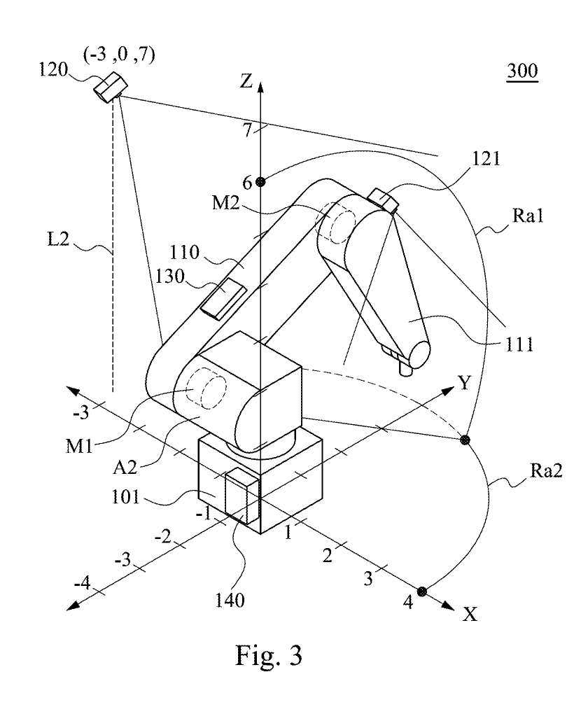

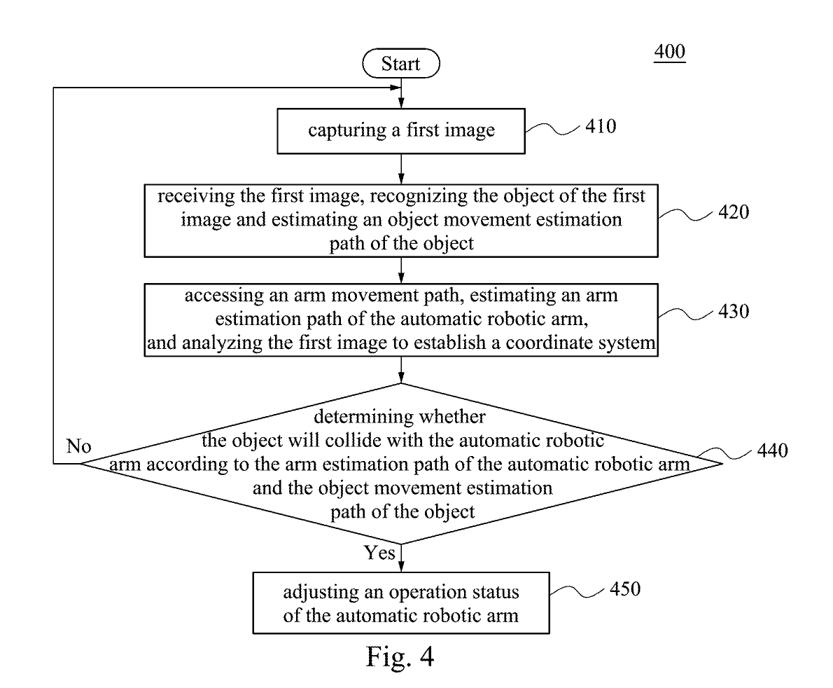

Next, reference is made to FIGS. 1, 3-4. FIG. 3 depicts a schematic diagram of an anti-collision system 300 according to one embodiment of the present disclosure. FIG. 4 depicts a flow chart of an anti-collision method 400 according to one embodiment of the present disclosure. It should be noticed that the present invention can be applied to many kinds of automatic robotic arms. Following embodiments describe the present invention by taking the selective compliance assembly robot arm shown in FIG. 1 and the six degrees of freedom robot arm shown in FIG. 2 as examples. The selective compliance assembly robot arm (e.g., four-axis robot arm) and the six degrees of freedom robot arm (six D.O.F. robot arm) separately have different configuration methods to place the image sensors. However, the person skilled in the art can easily understand that the present invention is not limited to the selective compliance assembly robot arm and the six degrees of freedom robot arm. The present invention can adjust the number and the position of the image sensors according to the type of the automatic robotic arm, so as to capture the operation of the automatic robotic arm.

In one embodiment, as shown in FIG. 1, the automatic robotic arm A1 is a selective compliance assembly robot arm. The stable base 101 of the selective compliance assembly robot arm A1 is configured as an original point of the coordinate system. The processing unit 131 controls a first arm 110 of the selective compliance assembly robot arm A1 by the controller 140. The controller 140 controls a motor M1 placed on the stable base 101 to drive the first arm 110 of the selective compliance assembly robot arm A1 moving on an X-Y plane.

In one embodiment, as shown in FIG. 1, the image sensor 120 is configured at the upward side of the selective compliance assembly robot arm A1. The image sensor 120 captures the image towards the selective compliance assembly robot arm A1 and the X-Y plane. For example, the image sensor 120 is configured on the axes L1. The axes L1 is perpendicular to the axes X (e.g., toward the position −2 of the axes X) and parallel to the axes Z. The coordination (X, Y, Z) of the image sensor 120 is about (−2, 0, 6). The axes L1 is a virtual axes for representing the configured position of the image sensor 120. However, the person skilled in the art can easily understand that the image sensor 120 can be configured in any position which can capture the image of the automatic robotic arm A1 on the X-Y plane in coordination system.

In another embodiment, as shown in FIG. 3, the automatic robotic arm A2 in FIG. 3 is implemented by six degrees of freedom robot arm. In this case, the controller 140 a motor M1 placed on a stable base 101 to drive a first arm 110 of the six degrees of freedom robot arm A2 moving on an X-Y plane, and the controller 140 controls a motor M2 to drive a second arm 111 of the six degrees of freedom robot arm A2 moving on a Y-Z plane.

In one embodiment, as shown in FIG. 3, the image sensor 120 is configured at the upward side of the six degrees of freedom robot arm A2. The image sensor 120 captures the images towards the six degrees of freedom robot arm A2 and the Y-Z plane. For example, the image sensor 120 is configured on the axes L2. The axes L2 is perpendicular to the axes X (e.g., toward the position −3 of the axes X) and parallel to the axes Z. The coordination (X, Y, Z) of the image sensor 120 is about (−3, 0, 7). The axes L2 is a virtual axes for representing the configured position of the image sensor 120. However, the person skilled in the art can easily understand that the image sensor 120 can be configured in any position which can capture the image of the automatic robotic arm A2 on the Y-Z plane in coordination system. Besides, the anti-collision system 300 further includes the image sensor 121 for capturing a second image. The second image sensor 121 is configured at a joint of the first arm 110 and the second arm 111 for capturing the second image toward the X-Y plane. The second image sensor 121 captures the image of the six degrees of freedom robot arm A2 on the X-Y plane.

Next, the following paragraphs describe the steps of the anti-collision method 400. The person skilled in the art can easily understand that the order of the following steps can be adjusted according to the practice condition.

In step 410, the image sensor 120 captures a first image.

In one embodiment, the image sensor 120 captures a region Ra1 of the selective compliance assembly robot arm A1 on an X-Y plane to obtain the first image.

It should be noticed that, for describing easily, the image(s) captured by the image sensor 120 at different time points is/are collectively called as the first image in the following statements.

In one embodiment, as shown in FIG. 3, the image sensor 120 captures a first region Ra1 of the six degrees of freedom robot arm A2 on the Y-Z plane to obtain the first image. And, the image sensor 121 captures a second region Ra2 of the six degrees of freedom robot arm A2 on the X-Y plane to obtain the second image.

It should be noticed that, for describing easily, the image(s) captured by the image sensor 121 at different time points is/are collectively called as the second image in the following statements.

Based on above, the automatic robotic arm A2 comprises the first arm 110 and the second arm 111 when automatic robotic arm A2 is the six degrees of freedom robot arm. And, the image sensor 121 can be mounted on the joint of the first arm 110 and the second arm 111 to capture the operation of the second arm 111 for more precisely determining that whether the second arm 111 will cause collision. Besides, the image sensor 120, 121 can separately obtain the first image and the second image. And, the image sensor 120, 121 can separately transmit the first image and the second image to the visual processing unit 132.

In step 420, the visual processing unit 132 uses for receiving the first image, recognizing the object OBJ of the first image and estimating an object movement estimation path “a” of the object OBJ.

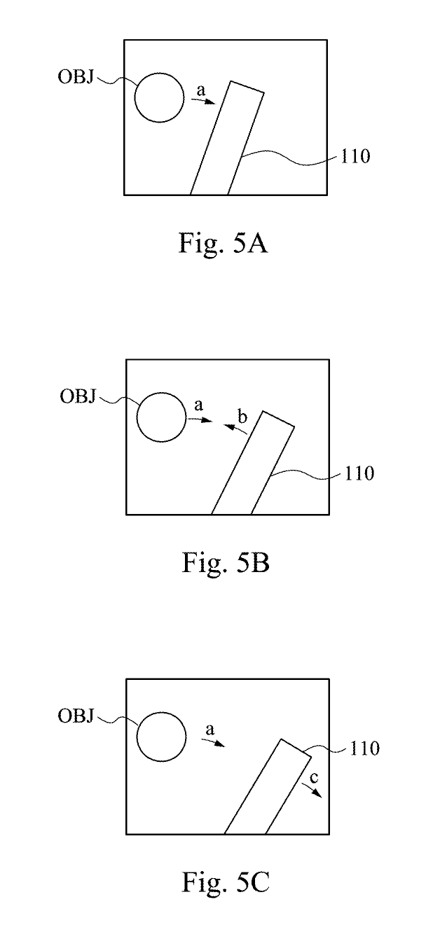

References are made to FIGS. 1 and 5A-5C, FIGS. 5A-2C depict schematic diagrams of the first image according to one embodiment of present disclosure. In one embodiment, the first image can be exampled by FIG. 5A. The visual processing unit 132 can use the known image recognition algorithm (e.g., the visual processing unit 132 can capture multiple first images to determine the moving part in each first image, or the visual processing unit 132 can recognize the color, shape or depth information of each block of each first image) to recognize the object OBJ.

In one embodiment, the visual processing unit 132 can estimate the object movement estimation path “a” of the object OBJ by optical flow. For example, the visual processing unit 132 compares the first one captured first image (which is captured firstly) and the second one captured first image (which is captured secondly). And, the visual processing unit 132 estimates that the object movement estimation path “a” of the object OBJ represents the memo vent of moving to the right side if the position of the object OBJ in the second one captured first image is on the right of the first one captured first image.

Therefore, the visual processing unit 132 can compare the first images captured at different time points to estimate the object movement estimation path “a” of the object OBJ and transmit the object movement estimation path “a” of the object OBJ to the processing unit 131.

In one embodiment, when the processing unit 131 has the better calculation ability, the vision processing unit 132 also can transmit the information of the recognized object OBJ to the processing unit 131. Thus, the processing unit 131 can estimate the object movement estimation path “a” according to the positions of the object OBJ in coordinate system corresponding to multiple time points.

In one embodiment, in the condition that the automatic robotic arm A2 is the six degrees of freedom robot arm (as shown in FIG. 3), if the visual processing unit 132 recognizes that both the first image (which is captured firstly) and the second image (which is captured secondly) comprise the object OBJ, the object movement estimation path “a” can be estimated according to the position of the object OBJ in the first image and the position of the object OBJ in the second image.

In step 430, the processing unit 131 uses for accessing an arm movement path, estimating an arm estimation path “b” of the automatic robotic arm A1, and analyzing the first image to establish a coordinate system.

In one embodiment, the processing unit 131 estimates the arm estimation path “b” of the automatic robotic arm A1 (as shown in FIG. 5B) according to a motion control code.

In one embodiment, the anti-collision system 100 includes a storage device for storing the motion control code. The motion control code can be predefined by user. And, the motion control code uses for controlling the operation direction, operation speed and operation function (e.g., picking or rotating a target object) of the automatic robotic arm A1 in each time point. Therefore, the processing unit 131 can estimate the arm estimation path “b” of the automatic robotic arm A1 by accessing the motion control code stored in the storage device.

In one embodiment, the image sensor 120 can continuously capture multiple first images. The processing unit 131 analyzes one of the first images to determine a datum point objects. And, the processing unit 131 configures the datum point objects as a center point coordinate and calibrates the center point coordinate according to another first image. In other words, the processing unit 131 can calibrate the center point coordinate according to the multiple first images captured at different time points. As shown in FIG. 1, the processing unit 131 analyzes a first image and determines the position of the stable base 101 in the first image. In one embodiment, the processing unit 131 analyzes the depth information of the first image to determine the relative distance and the relative direction between the stable base 101 and the image sensor 120, so as to determine the relative position between the stable base 101 and the image sensor 120. And, the processing unit 131 configures the position of the stable base 101 as center point coordinate (which is an absolute position) according to the relative position. The center point coordinate is (0, 0, 0).

Therefore, the processing unit 131 can analyze the first image to establish a coordinate system. The coordinate system can use for determining the relative position of each object (e.g. the automatic robotic arm A1 or the object OBJ) in the first image.

In one embodiment, after establishing the coordinate system, the processing unit 131 can receive the real-time signal from the controller 140 to obtain the current coordinate position of the first arm 110. And, processing unit 131 can estimate the arm estimation path “b” according to the coordinate position and the motion control code of the first arm 110.

In one embodiment, as shown in FIG. 1, the automatic robotic arm A1 includes a first arm 110. The processing unit 131 controls the first arm 110 by the controller 140. The controller 140 controls the first arm 110 to execute a maximum angle arm movement. And, the image sensor 120 captures the first image when the first arm 110 executes the maximum angle arm movement. In addition, the processing unit 131 analyzes the first image by a simultaneous localization and mapping (SLAM) technology to obtain at least one map feature appeared repeatedly in the first image, the at least one map feature uses for determining a position of the stable base 101. The processing unit 131 constructs a space topography according to the at least one map feature. Besides, the simultaneous localization and mapping technology is a known technology for estimating the position of automatic robotic arm A1 itself and linking the relationship between each component in the first image.

In one embodiment, as shown in FIG. 3, in the condition that the automatic robotic arm A2 is the six degrees of freedom robot arm (shown as FIG. 3), the processing unit 131 analyzes the first image to determine a datum point objects. The processing unit 131 configures the datum point objects as a center point coordinate. And, the processing unit 131 calibrates the center point coordinate according to the second image. In this step, other operation methods of the automatic robotic arm A2 in FIG. 3 is similar with the operation methods of the automatic robotic arm A1 in FIG. 1. Thus, we will not go further on this point herein.

In one embodiment, the order of the step 420 and the step 430 can be exchanged.

In step 440, the processing unit 131 determines whether the object OBJ will collide with the automatic robotic arm A1 according to the arm estimation path “b” of the automatic robotic arm A1 and the object movement estimation path “a” of the object OBJ. If the processing unit 131 determines the object OBJ will collide with the automatic robotic arm A1, the step 450 is performed. If the processing unit 131 determines the object OBJ will not collide with the automatic robotic arm A1, the step 410 is performed.

In one embodiment, the processing unit 131 determines that whether the arm estimation path “b” of the automatic robotic arm A1 and the object movement estimation path “a” of the object OBJ are overlapped at a specific time point. The processing unit 131 determines that the object OBJ will collide with the automatic robotic arm A1 if the processing unit determines that the arm estimation path “b” of the automatic robotic arm A1 and the object movement estimation path “b” of the object OBJ are overlapped at the specific time point.

For example, the processing unit 131 estimates that the position of the first arm 110 of the automatic robotic arm A1 is at coordinate (10, 20, 30) at 10:00 A.M. according to the arm estimation path “b”. And, the processing unit 131 estimates that the position of the first arm 110 of the automatic robotic arm A1 is also at coordinate (10, 20, 30) at 10:00 A.M. according to the object movement estimation path “a”. Therefore, the processing unit 131 determines that the path of the automatic robotic arm A1 and the object OBJ will be overlapped at 10:00 A.M., so as to determine the object OBJ will collide with the automatic robotic arm A1.

In one embodiment, when the automatic robotic arm A2 is a six degrees of freedom robot arm (as shown in FIG. 3), the processing unit 131 determines whether the object OBJ will collide with the automatic robotic arm A2 according to the arm estimation path “b” of the automatic robotic arm A2 and the object movement estimation path “a” of the object OBJ. If the processing unit 131 determines the object OBJ will collide with the automatic robotic arm A2, the step 450 is performed. If the processing unit 131 determines the object OBJ will not collide with the automatic robotic arm A2, the step 410 is performed. In this step, other operation methods of the automatic robotic arm A2 in FIG. 3 is similar with the operation methods of the automatic robotic arm A1 in FIG. 1. Thus, we will not go further on this point herein.

In step 450, the processing unit 131 adjusts an operation status of the automatic robotic arm A1.

In one embodiment, the processing unit 131 adjusts the operation status of the automatic robotic arm A1 as an adaptation mode (as shown in FIG. 5C, the processing unit 131 uses the controller 140 to control the automatic robotic arm A1 to follow the moving direction of the object OBJ, that is, the automatic robotic arm A1 is changed to move along the arm estimation path “c”), a slowdown operation mode, a path adjusting mode or a stop mode when the processing unit 131 determines that the arm estimation path “b” of the automatic robotic arm A1 and the object movement estimation path “a” of the object OBJ are overlapped (or crossed) at a specific time point. The adjustment of the operation status can be configured according to the practical condition.

In one embodiment, the processing unit further determines that whether a collision period is higher than a safety threshold (e.g., determining whether the collision period is higher than 2 seconds) when the processing unit 130 determines that the arm estimation path “b” of the automatic robotic arm A1 and the object movement estimation path “a” of the object OBJ are overlapped at a specific time point. If the processing unit 131 determines that the collision period is higher than the safety threshold, the processing unit 131 changes a current movement direction of the automatic robotic arm A1 (e.g., the processing unit 131 indicates the controller 140 to control the automatic robotic arm A1 moving to the opposite side). If the processing unit 131 determines that the collision period is not higher than the safety threshold, the processing unit 131 decreases current movements speed of the automatic robotic arm.

In this step, other operation methods of the automatic robotic arm A2 in FIG. 3 is similar with the operation methods of the automatic robotic arm A1 in FIG. 1. Thus, we will not go further on this point herein.

Accordingly, the anti-collision system and the anti-collision method use the vision processing unit to recognize the object of the image and estimate an object movement estimation path of the object. And, the processing unit can determine whether the object will collide with the automatic robotic arm according to the arm estimation path of the automatic robotic arm and the object movement estimation path of the object. Besides, if the processing unit determines that an unexpected object enters the operation region when the automatic robotic arm is operating, the processing unit can immediately commands the automatic robotic arm to stop moving or to enter the adaptation mode. It can prevent the automatic robotic arm from suffering the stress in the condition of reversing movement or counterforce status. As such, the anti-collision system and the anti-collision method can achieve the effect of preventing the object from colliding with the automatic robotic arm and preventing the servo motor from breakdown.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. An anti-collision system, for preventing an object from colliding with an automatic robotic arm, wherein the automatic robotic arm comprises a controller, and the anti-collision system comprising:
a first image sensor, configured to capture a first image;
a vision processing unit, configured to receive the first image, recognize the object of the first image and estimate an object movement estimation path of the object;
a processing unit, coupled to the controller to access an arm movement path, estimate an arm estimation path of the automatic robotic arm, analyze the first image to establish a coordinate system, and determine whether the object will collide with the automatic robotic arm according to the arm estimation path of the automatic robotic arm and the object movement estimation path of the object;
wherein the processing unit adjusts an operation status of the automatic robotic arm when the processing unit determines that the object will collide with the automatic robotic arm.

2. The anti-collision system of claim 1, wherein the automatic robotic arm is a six degrees of freedom robot arm, the controller controls a first motor placed on a stable base to drive a first arm of the six degrees of freedom robot arm moving on an X-Y plane, and the controller controls a second motor to drive a second arm of the six degrees of freedom robot arm moving on a Y-Z plane.

3. The anti-collision system of claim 2, further comprising:
a second image sensor, configured to capture a second image;
wherein, the first image sensor configured at the upward side of the six degrees of freedom robot arm for capturing a first region of the six degrees of freedom robot arm on the Y-Z plane to obtain the first image, and the second image sensor is configured at a joint of the first arm and the second arm for capturing a second region of the six degrees of freedom robot arm on the X-Y plane to obtain the second image.

4. The anti-collision system of claim 3, wherein the processing unit analyzes the first image to determine a datum point objects, and the processing unit configures the datum point objects as a center point coordinate and calibrates the center point coordinate according to the second image.

5. The anti-collision system of claim 1, wherein the automatic robotic arm is a selective compliance assembly robot arm, the controller controls a motor placed on a stable base to drive a first arm of the selective compliance assembly robot arm moving on an X-Y plane.

6. The anti-collision system of claim 5, wherein the first image sensor configured at the upward side of the selective compliance assembly robot arm for capturing a region of the selective compliance assembly robot arm on an X-Y plane to obtain the first image.

7. The anti-collision system of claim 1, wherein the automatic robotic arm comprises a first arm, the processing unit controls the first arm to execute a maximum angle arm movement, the first image sensor captures the first image when the first arm executes the maximum angle arm movement, the processing unit analyzes the first image by a simultaneous localization and mapping (SLAM) technology to obtain at least one map feature appeared repeatedly in the first image, the at least one map feature uses for determining a position of a stable base, and the processing unit constructs a space topography according to the at least one map feature.

8. The anti-collision system of claim 7, wherein the first image sensor is further configured to capture a plurality of first images at a plurality of different time points, the processing estimates the arm estimation path of the automatic robotic arm according to a motion control code, the vision processing unit estimates an object movement estimation path of the object by comparing the first images captured at different time points, the vision processing unit transmits the object movement estimation path of the object to the processing unit, the processing unit determines that whether the arm estimation path of the automatic robotic arm and the object movement estimation path of the object are overlapped at a specific time point, and the processing unit determines that the object will collide with the automatic robotic arm if the processing unit determines that the arm estimation path of the automatic robotic arm and the object movement estimation path of the object are overlapped at the specific time point.

9. The anti-collision system of claim 1, wherein the processing unit adjusts the operation status of the automatic robotic arm as an adaptation mode, a slowdown operation mode, a path adjusting mode or a stop mode when the processing unit determines that the arm estimation path of the automatic robotic arm and the object movement estimation path of the object are overlapped at a specific time point.

10. The anti-collision system of claim 1, wherein the processing unit further determines that whether a collision period is higher than a safety threshold when the processing unit determines that the arm estimation path of the automatic robotic arm and the object movement estimation path of the object are overlapped at a specific time point;
if the processing unit determines that the collision period is higher than the safety threshold, the processing unit changes a current movement direction of the automatic robotic arm; and
if the processing unit determines that the collision period is not higher than the safety threshold, the processing unit decreases a current movement speed of the automatic robotic arm.

11. An anti-collision method, for preventing an object from colliding with an automatic robotic arm, wherein the automatic robotic arm comprises a controller, and the anti-collision method comprising:
capturing a first image by a first image sensor;
receiving the first image, recognizing the object of the first image and estimating an object movement estimation path of the object by a vision processing unit; and
accessing an arm movement path, estimating an arm estimation path of the automatic robotic arm, analyzing the first image to establish a coordinate system, and determining whether the object will collide with the automatic robotic arm according to the arm estimation path of the automatic robotic arm and the object movement estimation path of the object by a processing unit coupled to the controller;
wherein the processing unit adjusts an operation status of the automatic robotic arm when the processing unit determines that the object will collide with the automatic robotic arm.

12. The anti-collision method of claim 11, wherein the automatic robotic arm is a six degrees of freedom robot arm, and the anti-collision method further comprising:
controlling a first motor placed on a stable base to drive a first arm of the six degrees of freedom robot arm moving on an X-Y plane by the controller, and
controlling a second motor to drive a second arm of the six degrees of freedom robot arm moving on a Y-Z plane by the controller.

13. The anti-collision method of claim 12, further comprising:
capturing a second image by a second image sensor;
wherein, the first image sensor configured at the upward side of the six degrees of freedom robot arm for capturing a first region of the six degrees of freedom robot arm on the Y-Z plane to obtain the first image, and the second image sensor configured at a joint of the first arm and the second arm for capturing a second region of the six degrees of freedom robot arm on the X-Y plane to obtain the second image.

14. The anti-collision method of claim 13, further comprising:
analyzing the first image to determine a datum point objects, configuring the datum point objects as a center point coordinate and calibrating the center point coordinate according to the second image by the processing unit.

15. The anti-collision method of claim 11, wherein the automatic robotic arm is a selective compliance assembly robot arm, and the anti-collision method further comprising:
controlling a motor placed on a stable base to drive a first arm of the selective compliance assembly robot arm moving on an X-Y plane by the controller.

16. The anti-collision method of claim 15, wherein the first image sensor configured at the upward side of the selective compliance assembly robot arm for capturing a region of the selective compliance assembly robot arm on an X-Y plane to obtain the first image.

17. The anti-collision method of claim 11, wherein the automatic robotic arm comprises a first arm, and the anti-collision method further comprising:
controlling the first arm to execute a maximum angle arm movement by the processing unit, the first image sensor captures the first image when the first arm executes the maximum angle arm movement; and
analyzing the first image by a simultaneous localization and mapping (SLAM) technology to obtain at least one map feature appeared repeatedly in the first image by the processing unit; wherein the at least one map feature uses for determining a position of a stable base; and
constructing a space topography according to the at least one map feature by the processing unit.

18. The anti-collision method of claim 17, further comprising:
capturing a plurality of first images at a plurality of different time points;
estimating the arm estimation path of the automatic robotic arm according to a motion control code by the processing unit;
estimating an object movement estimation path of the object by comparing the first images captured at different time points by the vision processing unit;
transmitting the object movement estimation path of the object to the processing unit by the vision processing unit; and
determining that whether the arm estimation path of the automatic robotic arm and the object movement estimation path of the object are overlapped at a specific time point by the processing unit;
wherein the processing unit determines that the object will collide with the automatic robotic arm if the processing unit determines that the arm estimation path of the automatic robotic arm and the object movement estimation path of the object are overlapped at the specific time point.

19. The anti-collision method of claim 11, wherein the processing unit adjusts the operation status of the automatic robotic arm as an adaptation mode, a slowdown operation mode, a path adjusting mode or a stop mode when the processing unit determines that the arm estimation path of the automatic robotic arm and the object movement estimation path of the object are overlapped at a specific time point.

20. The anti-collision method of claim 11, wherein the processing unit further determines that whether a collision period is higher than a safety threshold when the processing unit determines that the arm estimation path of the automatic robotic arm and the object movement estimation path of the object are overlapped at a specific time point;
if the processing unit determines that the collision period is higher than the safety threshold, the processing unit changes a current movement direction of the automatic robotic arm; and
if the processing unit determines that the collision period is not higher than the safety threshold, the processing unit decreases a current movement speed of the automatic robotic arm.
